(19) United States
(12) Patent Application Publication
(10) Pub. No.: US 2008/0283614 A1
(43) Pub. Date: Nov. 20, 2008

(54) Laminated transaction card with attached auxiliary member

(75) Inventor: Cindy Emery, Schaumburg, IL (US)

Correspondence Address: MCANDREWS HELD & MALLOY, LTD, 500 WEST MADISON STREET, SUITE 3400, CHICAGO, IL, 60661, US

(73) Assignee: Production Services Associates, LLC

(21) Appl. No.: 11/803,975

(22) Filed: May 16, 2007

(51) Int. Cl. G06K 19/00

(52) U.S. Cl. 235/487

(57) ABSTRACT

A transaction card assembly having a transaction card portion and an auxiliary member portion. The auxiliary member portion is attached in an edge-to-edge fashion between an edge of the transaction card and an edge of the auxiliary member portion. Both the transaction card and the auxiliary member are integrally formed from a substrate and a superposed layer. A line of weakness is formed in the substrate between the transaction card and the auxiliary member, such that, when the transaction card and auxiliary member are folded at the line of weakness, the superposed layer substantially resists breaking without the use of excessive force.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

The present invention relates to transaction cards such as gift cards and the like.

### BACKGROUND OF THE INVENTION

Transaction cards, such as audit cards and debit cards, membership cards, promotional cards, e.g., frequent flyer cards, identification cards, gift cards and the like, are widely used. Such transaction cards may include a variety of different indicia to identify the card itself, the individual using the card, a transaction account (such as a credit card account) or other features. The indicia may include a string of alphanumeric characters, a bar code or an encoded magnetic strip attached to the card.

Transaction cards have been produced that include an advertising portion attached along an edge of the card. For example, a prepaid phone card has been produced such that a rectangular transaction card has an advertising portion attached along an edge of the transaction card. That is, the transaction card and attached advertising portion are produced from a single piece of plastic or other material with a perforation or other line of weakness positioned between the transaction card and the advertising portion. The transaction card may be removed from the advertising section by bending or tearing along the perforation or line of weakness. Because these types of transaction cards are typically made out of thin materials, however, once the card is bent along the line of weakness between the card and the attached advertising portion, the transaction card and the advertising portion become completely separated with the application of very little force.

A vendor, however, may desire that the transaction card and auxiliary member would resist becoming detached. For instance, if the transaction card and auxiliary member become detached merely upon bending, most consumers simply throw the auxiliary member away immediately. In that case, the advertising or other information provided by the auxiliary member is lost. If the card and auxiliary member substantially resist breaking upon bending, however, then valuable advertising can remain with the transaction card and the consumer. Moreover, if the transaction card and auxiliary member do not become separated upon bending, then the vendor can stack the card assemblies for display without worrying about whether the cards will become separated from their auxiliary members. The ability to stack the assemblies, of course, saves shelf space for additional goods, which is a valuable selling point for any vendor. In addition, the card assemblies of the present invention allow a vendor to have information printed on both sides of the transaction card and both sides of the auxiliary member.

### SUMMARY OF THE INVENTION

In an illustrative embodiment of the invention, a transaction card assembly includes a transaction card having at least one auxiliary member attached at one edge of the card. A line of weakness is formed along the attachment edge. The attached transaction card and auxiliary member are both formed from a single laminate that comprises a substrate and a superposed layer on one side of the substrate such that, when the card/auxiliary member assembly is bent inwardly along the line of weakness with the superposed layer on the inside, the substrate breaks cleanly but the superposed layer substantially resists breaking without the use of excessive force.

### BRIEF DESCRIPTION OF THE DRAWINGS

Illustrative embodiments of the invention are described below with reference to the following drawings, in which like numerals reference like elements, and wherein:

FIG. 1 is a perspective view of a transaction card assembly in accordance with an embodiment of the invention, shown with the two portions of the assembly bent partially inwardly;

FIG. 2 is a cross-section of the transaction card assembly of FIG. 1 taken along line 2-2 of FIG. 1;

FIG. 3 is an alternative embodiment of the transaction card assembly disclosed herein;

FIG. 4 is another alternative embodiment of the transaction card assembly disclosed herein;

FIG. 5 is a perspective view of the transaction card assembly of FIG. 1 showing the two portions of the transaction card assembly completely bent inwardly;

FIG. 5A is an enlarged view of cut-out section 5A of FIG. 5;

FIG. 6 is a top view of the transaction card assembly of FIG. 1 showing the two portions of the assembly before either of the portions is bent inwardly toward the other;

FIG. 6A is a cross-sectional view of the transaction card assembly taken along line 6A-6A of FIG. 6; and

FIG. 7 is an alternative embodiment of the transaction card assembly disclosed herein.

### DETAILED DESCRIPTION OF THE INVENTION

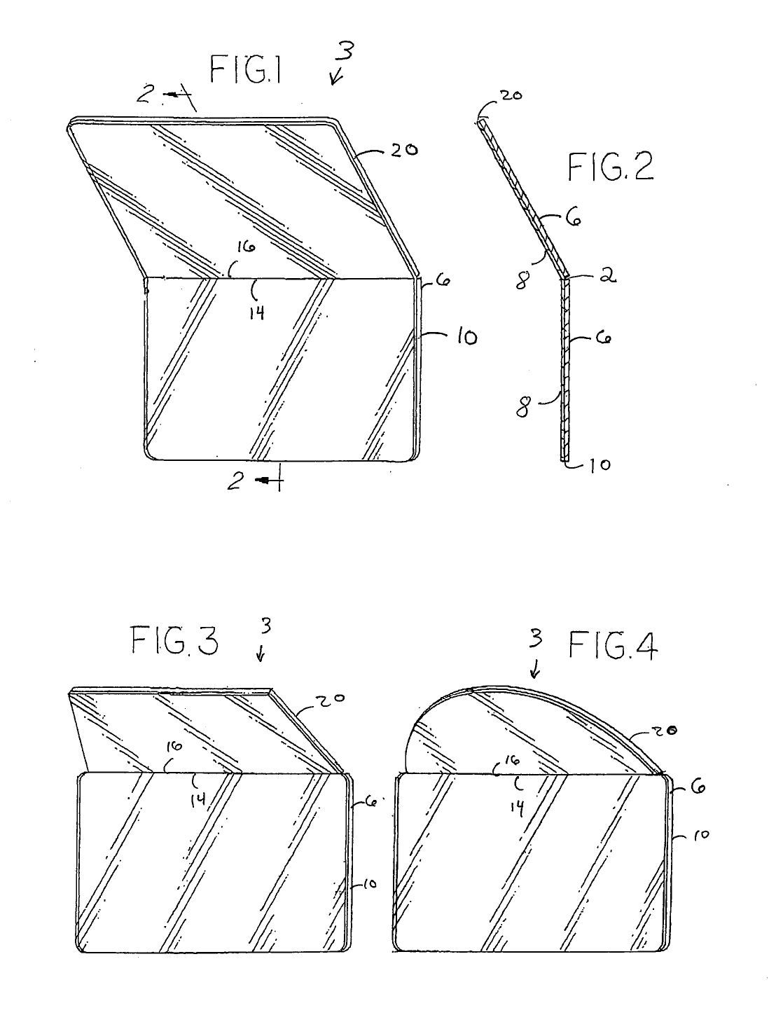

Referring now to FIGS. 1-7, the illustrated transaction card assembly 3 has a transaction card portion 10 and an auxiliary member portion 20. The transaction card portion 10 has an edge 14. The auxiliary member portion 20 may be another transaction card or it may instead serve to provide advertising or other information. The auxiliary member portion 20 has an edge 16. The auxiliary member portion 20 is attached in an edge-to-edge fashion at the edge 14 of the transaction card portion 10 and the edge 16 of the auxiliary member portion 20. Both the transaction card portion 10 and the auxiliary member portion 20 are integrally formed from a single laminate which is comprised of a substrate 6 and a superposed layer 8 on one side of the substrate 6. The substrate material 6 is preferably made of a poly-vinyl-chloride (PVC) polymer, but other polymers may be used. For example, the substrate 6 may be made of a polypropylene or a polyethylene material. The superposed layer 8 is preferably made of a translucent polymer film, and more specifically a polypropylene film. FIGS. 3 and 4 show exemplary alternative shapes of the auxiliary member portion 20.

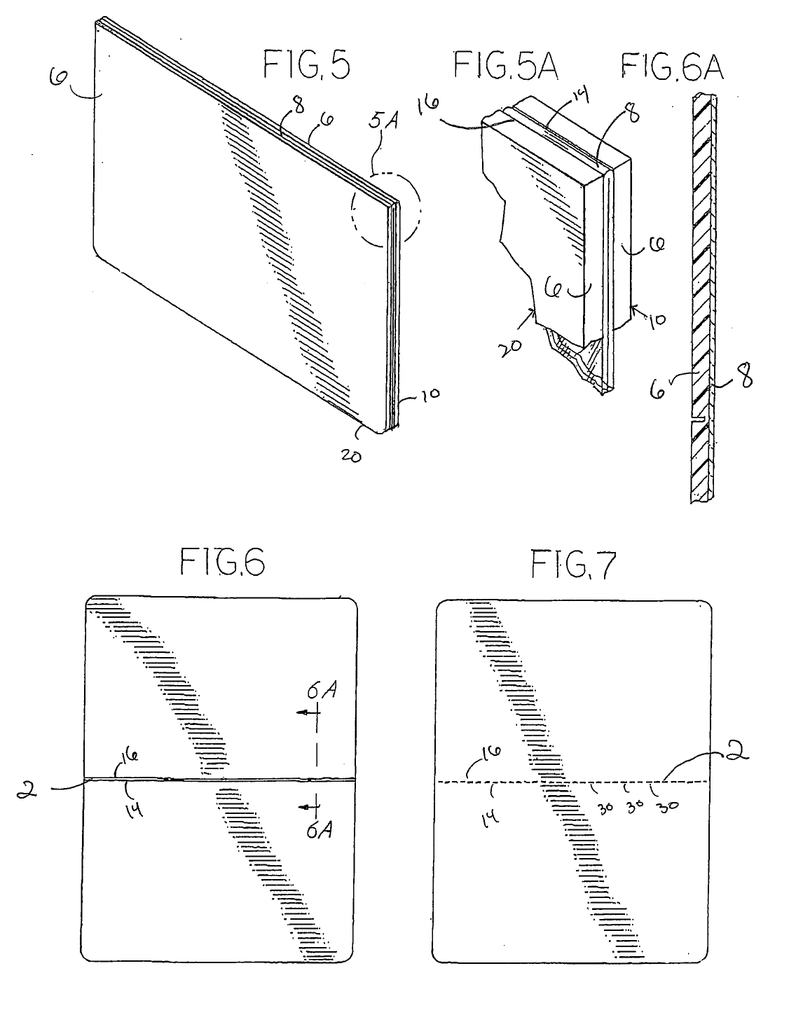

As best shown in FIG. 6, line of weakness 2 is formed in the substrate 6 along the edges 14 and 16 between the transaction card portion 10 and the auxiliary member portion 20. This line of weakness 2 is not formed in the superposed layer 8. In accordance with the invention, and as best shown in FIGS. 2, 5 and 5A, the layer 8 will not break along the edges 14 and 16 between the auxiliary member portion 20 and the transaction card portion 10 when the transaction card portion 10 and the auxiliary member portion 20 are bent toward each other along the line of weakness 2, with the superposed layer 8 on the inside, but the substrate 6 will break cleanly along the line of weakness 2. In order to accomplish this, and as discussed more fully below, the substrate 6 is cut only partially through between the edges 14 and 16 to form the line of weakness 2. Preferably, the line of weakness 2 is formed by cutting only three fourths of the way through the substrate 6, as best shown by reference to FIG. 6A, but other ratios may also be suitable. Alternatively, the line of weakness 2 may be formed by a series of perforations 30 between the edges 14 and 16 in the substrate 6, as shown in FIG. 7. Also as an alternative (not shown), the line of weakness 2 could be formed by a combination of cutting partially through between the edges 14 and 16 of the substrate 6 and adding a series of perforations as well.

In order to manufacture the transaction card assembly of the present invention, the layer 8 is superposed upon and adhesively applied to one side of the substrate material 6. The other side of the substrate material 6 is then die cut into individual assemblies, and the lines of weakness 2 are formed because the die cutters (not shown) are formed so as to cut only three fourths of the way through the substrate 6 (FIG. 6) or to provide perforations 30 (FIG. 7).

While the invention has been described in conjunction with specific embodiments thereof, it is evident that many alternatives, modifications, and variations will be apparent to those skilled in the art. Accordingly, embodiments of the invention as set forth herein are intended to be illustrative, not limiting. Various changes may be made without departing from the spirit and scope of the invention.

1. A transaction card assembly comprising:
a transaction card portion having a first edge;
an auxiliary member having a second edge, wherein the auxiliary member is attached in an edge-to-edge fashion at the first edge of the transaction card portion and the second edge of the auxiliary member, and wherein the transaction card portion and the auxiliary member are integrally formed from a single laminate comprising a substrate and a superposed layer;
a line of weakness formed in the substrate between the first edge of the transaction card portion and the second edge of the auxiliary member portion, wherein, when the transaction card portion and the auxiliary member portion are bent toward each other at the line of weakness with the superposed layer on the inside, the superposed layer substantially resists breaking without the use of excessive force.

2. The assembly of claim 1, wherein, when the transaction card portion and the auxiliary member portion are bent at the line of weakness, the substrate breaks between the first and second edges.

3. The assembly of claim 2, wherein the line of weakness comprises a perforated line.

4. The assembly of claim 2, wherein the line of weakness is formed by partially cutting the substrate to form the line of weakness.

5. The assembly of claim 4, wherein the substrate is cut ¾ of the way through along the line.

6. The assembly of claim 2, wherein the substrate is comprises a polymer.

7. The assembly of claim 6, wherein the polymer is poly-vinyl-chloride.

8. The assembly of claim 2, wherein the layer comprises a polymer film.

9. The assembly of claim 8, wherein the polymer film is polypropylene.

10. The assembly of claim 1, wherein the auxiliary member portion comprises a transaction card.

11. A transaction card assembly comprising:
a transaction card portion having a first edge;
an auxiliary member having a second edge, wherein the auxiliary member is attached in an edge-to-edge fashion at the first edge of the transaction card portion and the second edge of the auxiliary member, and wherein the transaction card portion and the auxiliary member are integrally formed from a single laminate comprising a substrate and a superposed layer;
a line of weakness formed in the substrate between the first edge of the transaction card portion and the second edge of the auxiliary member portion.

12. The assembly of claim 11, wherein, when the transaction card portion and the auxiliary member portion are bent toward each other with the superposed layer on the inside, the superposed layer resists breaking.

13. A transaction card assembly comprising:
a transaction card portion;
an auxiliary member attached to the transaction card portion, and wherein the transaction card portion and the auxiliary member are integrally formed from a single laminate comprising a substrate and a superposed layer.

14. The assembly of claim 13, wherein a line of weakness is formed in the substrate between a first edge of the transaction card portion and a second edge of the auxiliary member portion.

15. The assembly of claim 11, wherein, when the transaction card portion and the auxiliary member are bent toward each other with the superposed layer on the inside, the superposed layer resists breaking.
